(19) United States
(12) Patent Application Publication
(10) Pub. No.: US 2022/0166676 A1
(43) Pub. Date: May 26, 2022

(54) Apparatus, Program, and Method, for Resource Control

(71) Applicant: Telefonaktiebolaget LM Ericsson (publ), Stockholm (SE)

(72) Inventors: Vijaya Parampalli Yajnanarayana, Bangalore (IN); Sandhya Baskaran, Chennai (IN); Ankit Jauhari, Bangalore (IN)

(21) Appl. No.: 17/436,100

(22) PCT Filed: Mar. 23, 2019
(86) PCT No.: PCT/IN2019/050235

§ 371 Date: Sep. 3, 2021

(51) Int. Cl. H04L 41/0896; H04L 41/147; H04L 43/0876

(52) U.S. Cl. CPC H04L 41/0896; H04L 43/0876; H04L 41/147

(57) ABSTRACT

Embodiments include an apparatus comprising processor circuitry and memory circuitry, the memory circuitry storing processing instructions which, when executed by the processor circuitry, cause the processor circuitry to: at the end of a finite time period, performing an assignment of resources from a finite set of resources for performing tasks in a physical environment to pending tasks, including formulating the assignment, wherein formulating the assignment comprises: using a reinforcement learning algorithm to formulate a mapping that optimises a reward function value, the reward function value being a value generated by a predetermined reward function based on an inventory representing the resources, and a representation of the pending tasks, and the mapping, the mapping being a mapping of individual resources from the inventory to individual pending tasks in the representation, the formulated assignment being in accordance with the formulated mapping.

### TECHNICAL FIELD

The invention lies in the field of resource control and resource management. In particular, embodiments relate to the assignment of limited resources to a dynamically changing set of tasks in a physical environment such as a telecommunications network.

### BACKGROUND

A typical telecommunication network includes a vast interconnection of elements such as base-station nodes, core-network components, gateways, etc. In such a system it is natural to have malfunctions in its various software and hardware components. These are reported through incidents or tickets. The network maintenance team needs to resolve them efficiently to have a healthy telecom network. Typically, these maintenance teams need an optimal rule to assign the available fixed assets/resources such as person, tools, equipments, etc, to the unresolved (active/pending) tickets. The number of active tickets in the system is dynamically changing as some tickets leaves the system when they are resolved, and new tickets enter the system due to new incidents or malfunctions in the network. This makes it difficult to find an optimal rule to allocate the fixed assets to active tickets.

Although there are existing methods that assign the resources to the ticket based on optimal planning, this is often done with respect to only the current ticket at hand and the assignment is oblivious to the long-term impact of such an assignment on the system. For example, an existing approach is to map the assets to the tickets manually. Whenever a ticket arrives in a network operations center, NOC, the NOC administrator assigns the required assets from those available, with the aim of resolving the ticket as soon as possible. While this approach may cope effectively with tickets currently in the system, in due course the greedy/selfish approach to asset utilization will start draining assets, and cause future tickets to have a longer resolution time (as assets required by the future tickets are engaged by the recently arrived tickets).

The problem of assigning assets to resources is discussed in: Ralph Neuneier, “Enhancing Q-Learning for Optimal Asset Allocation”, NIPS 1997: 936-942 URL: https://pdfs.semanticscholar.org/948d/17bcd496a81da630aa947a83e6c01fe7040c .pdf; and Enguerrand Horel, Rahul Sarkar, Victor Storchan, “Final report: Dynamic Asset Allocation Using Reinforcement Learning”, 2016 URL: https://cap.stanford.edu/profiles/cwmd?fid=69080&cwmId=6175

The approaches disclosed above cannot be applied to dynamically changing task scenarios in physical environments.

It is desirable to provide a technique for controlling assignments of resources to pending tasks in a dynamic physical environment that at least partially overcomes limitations of dealing with each pending task on an individual basis in order of arrival.

### SUMMARY

Embodiments include an apparatus comprising processor circuitry and memory circuitry, the memory circuitry storing processing instructions which, when executed by the processor circuitry, cause the processor circuitry to: at the end of a finite time period, perform an assignment of resources from a finite set of resources for performing tasks in a physical environment to pending tasks, including formulating the assignment, wherein formulating the assignment comprises: using a reinforcement learning algorithm to formulate a mapping that optimises a reward function value, the reward function value being a value generated by a predetermined reward function based on an inventory representing the resources, and a representation of the pending tasks, and the mapping, the mapping being a mapping of individual resources from the inventory to individual pending tasks in the representation, the formulated assignment being in accordance with the formulated mapping.

The set of resources may also be referred to as a set of assets, or fixed assets. The finite nature of the resources indicates that the assignment of a resource to a pending task negatively influences the availability of resources for other pending tasks. In the case of an infinite resource, the same is not true.

The finite time period may be a finite temporal episode, a predetermined window of time, a fixed cycle, or a predetermined frequency. For example, running from a predetermined start point to a predetermined end point. Time period may be taken to be equivalent in meaning to time window or temporal episode or temporal period. The finite time period may be one of a series of continuous finite time periods.

Simply increasing the number of assets may not be possible or feasible, so embodiments provide a technique to achieve effective usage of a fixed amount of resource. Embodiments provide an efficient mechanism to assign and handle available assets/resources, by using a reinforcement learning algorithm to formulate a mapping to resolve as many tickets as possible with minimum assets required.

Advantageously, embodiments wait until the end of a time period and deal with mapping resources to all pending tasks at the end of the episode collectively. In this manner, an assignment is achieved which is sympathetic to a group of pending tasks collectively, rather than simply implementing the best solution for each pending task individually.

The reinforcement learning algorithm may operate based on associations between characteristics of the tasks and resources, respectively. For example, the representation of the set of tasks may comprise, for each member of the set of tasks, one or more task characteristics. The inventory may comprise, for each resource represented in the inventory, one or more resource characteristics. The reinforcement learning algorithm being configured to learn and store associations between task characteristics and resource characteristics; and the formulating the mapping including constraining the mapping of individual resources from the inventory to individual pending tasks in the representation to resources having a resource characteristic associated with a task characteristic of the respective individual pending task in the stored associations.

Advantageously, the stored associations provide a mechanism by which the reinforcement learning algorithm can formulate potential mappings for assessment with the reward function.

Furthermore, the reinforcement learning algorithm may be configured to learn and store an association between a task characteristic and a resource characteristic in response to a notification that a resource having the resource characteristic and having been assigned to a task having the task characteristic, has successfully performed the task.

Advantageously, the reinforcement learning algorithm receives feedback on past assignments in order to inform and improvise future assignments.

In particular, the reinforcement learning algorithm may be configured to learn and store associations between task characteristics and resource characteristics in response to information representing outcomes of historical assignments of resources to tasks, and the respective resource characteristics and task characteristics, wherein the stored associations include a quantitative assessment of strength of association, the quantitative assessment between a particular resource characteristic and a particular task characteristic being increased in response to information indicating a positive outcome of an assignment of a resource having the particular resource characteristic to a task having the particular task characteristic.

Advantageously, such quantitative assessments may provide a means by which to select between a plurality of candidate mappings where there exists a plurality of feasible mappings.

As a further technique for quantifying strength of associations between tasks and resources, it may be that the quantitative assessment between a particular resource characteristic and a particular task characteristic is decreased in response to information indicating a negative outcome of an assignment of a resource having the particular resource characteristic to a task having the particular task characteristic.

Embodiments leverage a reward function to assess potential mappings, and to configure and formulate a mapping in the data space to implement as an assignment in the physical environment. The predetermined reward function is a function of factors resulting from the formulated mapping, the factors including one or more from among: a number of tasks predicted for completion, a cumulative time to completion of the number of tasks, etc.

Embodiments may utilise the reward function to factor a consumption overhead (such as cost or CO2 emission) associated with using a particular resource. For example, the resources may include one or more resources consumed by performing the tasks, the inventory comprising an indication of a consumption overhead of the resources, in which case the reward function factors may include: a predicted cumulative consumption overhead of the mapped resources.

An example of further factors that may be included in the reward function includes a usage rate of the finite set of resources, there being a negative relation between reward function value optimisation and the usage rate.

Embodiments are applicable in a range of implementations. For example, the physical environment may be a physical apparatus and each pending task is a technical fault in the physical apparatus, and the representation of the pending tasks is a respective fault report of each technical fault; and the resources for performing tasks are fault resolution resources for resolving technical faults.

In particular, it may be that the physical apparatus is a telecommunications network.

The malfunctions in the typical telecommunication network may be reported through incidents or tickets. These tickets need to be resolved by optimally utilizing the available assets in short amount of time. The number of active tickets in the system is dynamically changing as some tickets leaves the system when it is resolved, and new tickets enter the system due to the malfunctions in the network. The tickets are a representation of pending tasks. Conventional methods allocate the resources to the ticket either manually or by using simple rules, which only consider the current ticket at hand and is oblivious to the long-term impact of such choice on asset utilization, collective statistics on ticket resolution times, etc. Embodiments leverage an evaluative feed-back based learning system to address such shortcomings. Embodiments provide a reinforcement learning frame work with a strategy for state (inventory and representation of resources), action (mapping & assignment) and reward (reward function) spaces to allocate the available resources to the open tickets whilst suppressing resource utilisation rates in order to keep resources available for future assignment.

Embodiments may also comprise interface circuitry, the interface circuitry configured to assign the resources in accordance with the formulated mapping by communicating the formulated mapping to the set of resources.

Embodiments include a computer-implemented method, comprising: at the end of a finite time period, performing an assignment of resources from a finite set of resources for performing tasks in a physical environment to pending tasks, including formulating the assignment, wherein formulating the assignment comprises: using a reinforcement learning algorithm to formulate a mapping that optimises a reward function value, the reward function value being a value generated by a predetermined reward function based on an inventory representing the resources, and a representation of the pending tasks, and the mapping, the mapping being a mapping of individual resources from the inventory to individual pending tasks in the representation, the formulated assignment being in accordance with the formulated mapping.

Embodiments also include a computer program which, when executed by a computing device having processor hardware, causes the processor hardware to perform a method comprising: at the end of a finite time period, performing an assignment of resources from a finite set of resources for performing tasks in a physical environment to pending tasks, including formulating the assignment, wherein formulating the assignment comprises: using a reinforcement learning algorithm to formulate a mapping that optimises a reward function value, the reward function value being a value generated by a predetermined reward function based on an inventory representing the resources, and a representation of the pending tasks, and the mapping, the mapping being a mapping of individual resources from the inventory to individual pending tasks in the representation, the formulated assignment being in accordance with the formulated mapping.

### BRIEF DESCRIPTION OF THE DRAWINGS

Embodiments will now be described, purely by way of example, with reference to the accompanying drawings, in which:

FIG. 1 illustrates a flow of logical steps in a process of an embodiment;

FIG. 2 illustrates an apparatus of an embodiment;

FIG. 3 illustrates an apparatus of an embodiment; and

FIG. 4 illustrates an implementation of an embodiment.

### DETAILED DESCRIPTION

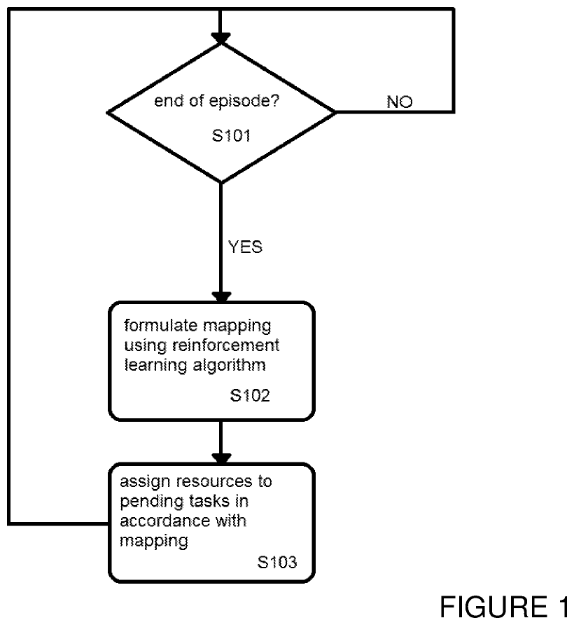

FIG. 1 illustrates a flow of logical steps in a process of an embodiment. For example, the process may be an embodiment itself, or may be performed by an embodiment.

Steps S101 to S103 represent a process of assigning resources from a finite set of resources for performing tasks in a physical environment to pending tasks, including formulating the assignment.

The process defines a loop, so that it may be performed continuously. It may be that a default fixed time step is implemented between subsequent instances of S101. For example, the time step may be a fixed relation to the length of an episode, such is 0.1×, 0.5×, or 1×, the length of an episode. Or the time step may be a fixed length of time, such as 1 minute, 10 minutes, 30 minutes, or 1 hour.

Embodiments do not assign resources to a new pending task in direct response to the task becoming pending (i.e. arriving or being reported). Instead, embodiments wait at least until the end of the episode during which a new pending task became pending to assign resources to the task. The time at which a task becomes pending may be the time at which the task is reported to the embodiment, or the time at which the embodiment otherwise becomes aware of the pending task.

Step S101 checks whether the end of an episode (i.e. the end of a predetermined time period) has been reached. For example, step S101 may include processor hardware involved in the performance of the process of FIG. 1 performing a call to an operating system, system clock, or an external application providing live time data, to check whether a current time matches a time at which a current episode is scheduled to end. Alternatively, it may be that a timer is started at the end of each period, which timer uses a system clock to track time since end of the previous period, and that when the elapsed time since the end of the previous period is equal to the duration of an episode, the flow proceeds to step S102, and the timer is reset to 0 and re-started.

At S102, a mapping is formulated between a representation of available resources and a representation of the pending tasks. For example, step 102 may include using a reinforcement learning algorithm to formulate a mapping that optimises a reward function value, the reward function value being a value generated by a predetermined reward function based on an inventory representing the resources, and a representation of the pending tasks, and the mapping, the mapping being a mapping of individual resources from the inventory to individual pending tasks in the representation.

The mapping is on a logical level, and may be a data processing step. Resources are finite resources for performing tasks, such as manual resources, and hardware. A data representation of the resources may be referred to as an inventory. The inventory is a record in data of the resources, and may include an indication of the availability of the resource such as scheduling information or simply a flag indicating the resource is available or unavailable. In other words, the inventory may be a manifestation of the resources in a memory or data store. The inventory is dynamic, changing to represent one or more from among changes in availability of resources, changes in characteristic of the resource, a resource being added to or removed from the set of resources. Pending tasks are faults that need repairing in a physical environment, or some other form of task in a physical environment. The representation of pending tasks is also dynamic, changing as pending tasks are received by the embodiment or otherwise notified to the embodiment, and to represent tasks that are no longer pending because they are either being performed or are completed.

The mapping links a data representation of the pending tasks to a data representation of the resources. In particular, the mapping is formulated by using a reinforcement learning algorithm to optimise a reward function value. The mapping may be formulated by executing an algorithm on input data including a current version of the inventory and a current representation of pending tasks, wherein current may be taken as at the end of the most recently finished episode.

The representation of the set of tasks may comprise, for each member of the set of tasks, one or more task characteristics. For example, the task characteristics may define one or more from among a length of time the task is expected to take to complete, a time by which the time is to be completed, a descriptor of the task, a task ID, an indication of resources required to complete the task, an indication of resource characteristics required to complete the task, a cost ceiling or cost range (wherein cost anywhere in this document may refer to financial, performance, or CO2 emission), and a geographic location of the task.

The inventory may comprise, for each resource represented in the inventory, one or more resource characteristics. For example, the resource characteristics may include one or more from among: resource cost, resource availability, resource ID, resource type, task(s) of type(s) of tasks that the resource can complete, geographic location, geographic range.

The reinforcement learning algorithm may be configured to learn and store associations between task characteristics and resource characteristics, so that the formulating the mapping includes constraining the mapping of individual resources from the inventory to individual pending tasks in the representation, to resources having a resource characteristic associated with a task characteristic of the respective individual pending task in the stored associations. The reinforcement learning algorithm may learn the associations by monitoring past assignments of resources to tasks and the outcomes of those assignments. For example, the reinforcement learning algorithm is configured to learn and store an association between a task characteristic and a resource characteristic in response to a notification that a resource having the resource characteristic and having been assigned to a task having the task characteristic, has successfully performed the task. For example, associations may be weighted, with weightings being incrementally increased by an assignment resulting in a task being completed or being incrementally decreased by an assignment resulting in an incomplete task. Optionally, the increment and/or decrement may be inversely proportional to time taken.

The mapping finds an assignment of resources to pending tasks that will optimise a reward function. The reward function generates a reward function value representing a formulated mapping, wherein the mapping is itself a variable or factor influencing reward function value. The reinforcement learning algorithm is responsible for finding the mapping of resources to pending tasks, according to the representation of pending tasks and the inventory, that will generate an optimum (i.e. highest or lowest, depending on the configuration of the function) reward function value.

The reinforcement learning algorithm may be in a feedback loop in which information about implemented assignments, such as time to complete each pending task within the assignment, rate of task completion, cost of implementation, CO2 cost of implementation, among others, are fed back to the algorithm. The feedback algorithm can be used by the reinforcement learning algorithm to configure the reward function and/or predict factors of the reward function that influence the reward function value.

The predetermined reward function is predetermined with respect to its execution for a particular episode (i.e. the reward function is fixed at time of completion of the episode), but the reward function may be configurable between executions, for example, in response to observed assignment outcomes. The predetermined reward function is a function of factors to which the reinforcement learning algorithm attributes values in formulating a mapping, the values being combined to generate the reward function value. The reinforcement learning algorithm may execute an iterative process of repeatedly adapting a mapping and assessing the reward function value for the adapted mapping, in formulating a mapping that optimises reward function value.

The reinforcement learning algorithm may also be configured, during a training or observation phase, to adapt the reward function so that assignments observed during the training/observation phase and which lead to beneficial outcomes (i.e. low cost, efficient use of resources) are favoured over assignments leading to poor outcomes (i.e. high cost, inefficient use of resources). The reinforcement learning algorithm may be configured to learn and store associations between task characteristics and resource characteristics in response to information representing outcomes of historical assignments of resources to tasks, and the respective resource characteristics and task characteristics. The stored associations include a quantitative assessment of the association, the quantitative assessment between a particular resource characteristic and a particular task characteristic being increased in response to information indicating a positive outcome of an assignment of a resource having the particular resource characteristic to a task having the particular task characteristic. The quantitative assessment between a particular resource characteristic and a particular task characteristic is decreased in response to information indicating a negative outcome of an assignment of a resource having the particular resource characteristic to a task having the particular task characteristic.

It may be desirable to assign resources in a manner which suppresses resource usage. This is enabled by embodiments that in include usage rate of the resources as a factor of the predetermined reward function. There is a negative relation between reward function value optimisation and usage rate, so that the reward function tends to be optimised for lower resource usage rates.

The mapping may be in the form of a schedule indicating which resources are assigned to which pending tasks, and when, wherein the when may be indicated as an absolute time or as a timing relative to another pending task (e.g. resource B is assigned to task 1, and after task 1 is complete, resource B is assigned to task 2).

Once the mapping is formulated, the resources are assigned to pending tasks in accordance with the mapping, at S103. The formulation of the mapping at S102 is a data processing operation. The assignment of resources to tasks relates to the assignment of the resources themselves to the pending tasks in the physical environment. The assignment may be implemented by the publication of a schedule, by the issuing of instructions or commands to resources, and may include transmitting or otherwise moving resources to a location at which a pending task is to be performed.

The resources are composed wholly or partially of finite resources. Finite resources are resources which cannot be simply be replicated on demand without limitation. That is, resources of which there is a limited number or amount. The resources may include infinite resources with no realistic limitation on number or replication (an example of a resource may be a password required to access a secure storage, or a further example is an electronic instruction manual). The finite resources may include, for example, licences for computer software required to perform a pending task, wherein the assigning includes making the software licence available to the user or entity performing the respective pending task.

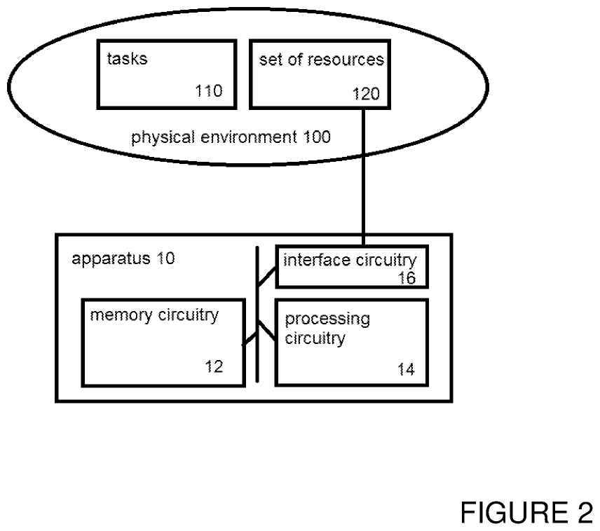

FIG. 2 illustrates an apparatus 10 of an embodiment. The apparatus 10 includes memory circuitry 12, processing circuitry 14, and interface circuitry 16. In the physical environment 100 in which the pending tasks 110 are to be performed, there is a set of resources 120. A link between the set of resources 120 and the memory circuitry is indicative of a link by which an assignment of resources 120 to tasks 110 is communicated to the resources 120. However, it is not exclusive of other logical and communication links between the physical environment 100 and the apparatus 10.

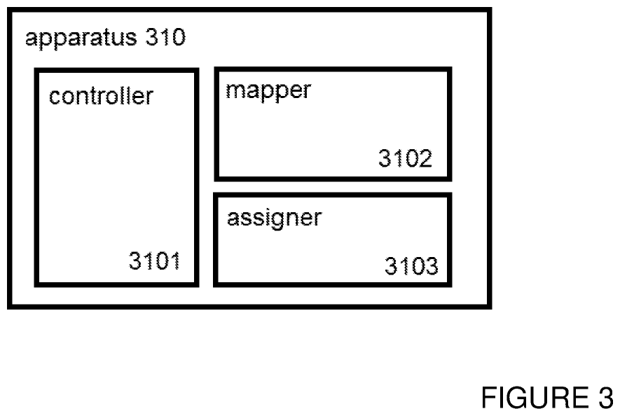

The apparatus 10 may perform some or all of the steps of the method of FIG. 1, for example, on receipt of suitable instructions from a computer program. The apparatus 10 may for example be located in a server of or connected to a core network, a base station or other radio access node, or a server in a data center running one or more virtual machines executing the steps of the method of FIG. 1. Referring to FIG. 3, the apparatus 10 comprises a processor or processing circuitry 14, a memory 12, and interfaces 16. The memory 12 contains instructions executable by the processor 14 such that the apparatus 10 is operative to conduct some or all of the steps of the method of FIG. 1. The instructions may also include instructions for executing one or more telecommunications and/or data communications protocols. The instructions may be stored in the form of a computer program on the memory 12 or otherwise accessible to the processor 14. In some examples, the processor or processing circuitry 14 may include one or more microprocessors or microcontrollers, as well as other digital hardware, which may include digital signal processors (DSPs), special-purpose digital logic, etc. The processor or processing circuitry 14 may be implemented by any type of integrated circuit, such as an Application Specific Integrated Circuit (ASIC), Field Programmable Gate Array (FPGA) etc. The memory 12 may include one or several types of memory suitable for the processor, such as read-only memory (ROM), random-access memory, cache memory, flash memory devices, optical storage devices, solid state disk, hard disk drive etc.

The physical environment 100 is an environment in which the pending tasks 110 are to be performed. For example, the physical environment 100 may be a telecommunications network and the pending tasks may be faults to be remedied. The set of resources 120 are a finite set of resources which may be used in performing the tasks. The resources are finite, so the set is changed by the assignment of a resource 120 to a task 110, because the number or amount of that resource available to perform other tasks is reduced, at least for the duration of time it takes to perform the pending task.

The apparatus 10 maintains a representation of the state of the physical environment 100, at least in terms of maintaining a representation of pending tasks 110, which is dynamic as new tasks become pending and existing pending tasks are completed, and a representation of resources (inventory) and their availability for being assigned to, and performing, pending tasks. The representations may be stored by the memory circuitry 12, and may be updated by information received via the interface circuitry 16. Such information may include one or more from among: reports of new pending tasks, information indicating completion of previously pending tasks, information representing availability of a resource, information indicating geographic location of a resource, information representing performance of a pending task being initiated.

The representations are used by the apparatus 10 to formulate a mapping of resources to tasks, using a reinforcement learning algorithm to find a mapping which optimises a reward function value, the reward function being based on factors including one or more from among number of pending tasks that will be completed by the mapping, a total or average time to completion of the tasks (or a cumulative pendency time of the tasks), net consumed resources, and resource utilisation rate.

The formulated mapping is the mapping arrived at by the apparatus 10 that optimises the reward function value for the given inputs, i.e. the representation of the pending tasks in the physical environment at the end of an episode, and the representation (inventory) of resources in the physical environment at the end of the episode.

Once the mapping has been formulated, the apparatus 10 performs the assignment of resources 120 to tasks 110. For example, the assignment may be performed via the interface circuitry 16. The interface circuitry may be a node in a network in communication with one or more of the resources 120 in the physical environment 100 via the network. The resources 120 may be instructed by, or controlled by, devices in the network. The network may be, for example, a computer network, or a telecommunications network. The form of the assignment may be outputting data representing a schedule or set of instructions implementing the mapping, which data is readable by the set of resources 120 to implement the mapping/assignment.

FIG. 3 illustrates another example of apparatus 310, which may also be located in a server of or connected to a core network, a base station or other radio access node, or a server in a data center running one or more virtual machines executing the steps of the method of FIG. 1. Referring to FIG. 3, the apparatus 310 comprises a plurality of functional modules, which may execute the steps of the method of FIG. 1 on receipt of suitable instructions for example from a computer program. The functional modules of the apparatus 310 may be realised in any appropriate combination of hardware and/or software. The modules may comprise one or more processors and may be integrated to any degree. The apparatus 310 is for performing an assignment of resources from a finite set of resources for performing tasks in a physical environment to pending tasks, including formulating the assignment. Referring to FIG. 3, the apparatus 310 comprises a controller or controller module 3101 for determining when a finite time period is complete, and for obtaining input data, including a data representation of pending tasks in a physical environment, and a data representation of resources for performing tasks in the physical environment. The apparatus 310 further comprises a mapper or mapping module 3102 for using a reinforcement learning algorithm to formulate a mapping that optimises a reward function value, the reward function value being a value generated by a predetermined reward function based on an inventory representing the resources, and a representation of the pending tasks, and the mapping, the mapping being a mapping of individual resources from the inventory to individual pending tasks in the representation. The apparatus 310 further includes an assigner or assignment module 3103 for assigning the resources to the tasks in accordance with the mapping, for example, by instructing or otherwise outputting a schedule implementing or otherwise representing the formulated mapping to the resources in the physical environment.

As will be demonstrated in the below implementation example, embodiments may be applied to assigning resources to faults in a telecommunication network, as an example of the physical environment.

Embodiments formulate a mapping of fixed assets (people, skills, tools, equipment, etc.), exemplary of resources, to tickets reporting faults, exemplary of a pending task representation, using a reinforcement learning method. Embodiments provide or implement a process which acts on the dynamic physical environment (represented by the active tickets) to select an action (represented by the mapping of assets to tickets) such that long term reward is maximized. The action is an assignment of assets to technical faults, and the long term reward is represented by a reward function that a reinforcement learning algorithm optimizes by formulating mappings of assets to tickets.

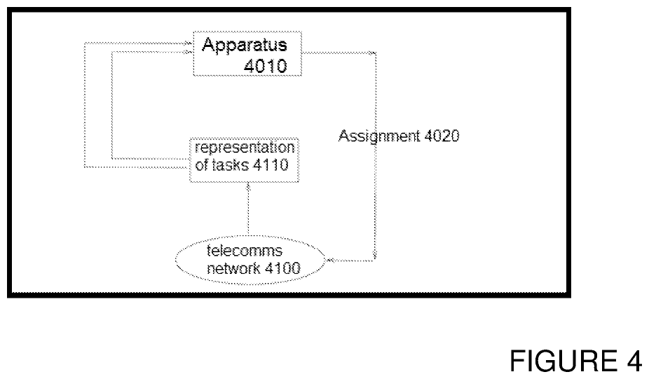

FIG. 4 illustrates an embodiment implemented for ticket handling in a telecommunications network. The apparatus 4010 may have the arrangement and functionality of the apparatus 10 of FIG. 2, the apparatus 310 of FIG. 3, or a combination thereof. The apparatus 4010 performs a method exemplary of the method illustrated in FIG. 1. The assignment 4020 is an assignment of assets to tickets for the ith time period, and hence may be referenced Aᵢ. The assignment 4020 is exemplary of the assignment output by the interface circuitry 16 to the set of resources 120 in FIG. 2, such as data representing a schedule or set of instructions implementing a mapping of resources (assets) to tasks (tickets). The assignment 4020 is exemplary of the output of the assigner 3103 of FIG. 3. The telecom network 4100 is exemplary of a physical environment 100 of FIG. 2. The representation of tasks in the environment 4110 is exemplary of the representation of pending tasks referred to elsewhere in the present document. The representation of tasks in the environment 4110 may be referred to as a status of the environment. The representation of tasks in the environment 4110 may be a representation of the pending tasks at the end of a time period. Specifically, the representation of pending tasks at the end of the ith episode may be referred to by the symbol Sᵢ. The representation of tasks in the environment 4110 is illustrated between the apparatus 4010 and telecom network 4100 in FIG. 4. The placement is illustrative of data exchange between the telecom network 4100 and the apparatus 4010 that enables the apparatus 4010 to have knowledge of pending tasks in the environment. For example, the data exchange may be submission of fault tickets from the telecom network 4100 to the apparatus 4010, wherein each fault ticket is a representation of a pending task. The individual fault tickets may not be aggregated until they reach the apparatus 4010, so that it may be considered that the representation of tasks in the environment at the end of episode i does not exist as a single entity other than in the apparatus 4010. Alternatively, it may be that aggregation of tickets is performed in the telecommunications network 4100 at predetermined timings, such as at the end of an episode, and the aggregate reported to the apparatus 4010.

The apparatus 4010 obtains, generates, receives, or otherwise acquires, a representation of pending tasks in the environment 4010 in regular intervals called episodes, at the end of each episode. For example, the representation may comprise a set of active tickets, wherein active indicates that they are pending. Pending may indicate that the task is not yet complete, alternatively, pending may indicate that no asset or resource is assigned to the task. Alternatively, pending may indicate that performance of the task is not yet initiated. These three interpretations of pending are relevant in the implementation of FIG. 4 and in the remaining embodiments.

At the end of episode i, the environment is defined by Sᵢ (which is an instance of the representation of pending tasks in the environment 4110), the apparatus 4010 will formulate an assignment 4020, Aᵢ, (implementing a mapping of assets to tickets) such that the long term reward is maximized according to the (as measured by the reward function). Once the choice of state space Sᵢ, action space Aᵢ, and the reward, Rᵢ, is designed then standard RL method can be employed to optimize the rule for mapping the tickets to the fixed assets.

In the implementation of FIG. 4, the representation of pending tasks 4110 at the end of the ith episode may be represented by S∈{T₁, . . . , T_{X}} where X indicates the number of active tickets, and Tⱼ is an individual active (i.e. pending) ticket. The assignment 4020 formulated by the apparatus 4010 and initiated or instructed in the telecommunications network 4100 may be represented as A∈{c₁, . . . , c_{X}}, where cᵢ, i∈{1, . . . , X}, denotes the assets mapped to tickets Tᵢ, i∈{1, . . . , X} respectively.

The reward at episode i for a formulated mapping to be applied to a given state (i.e. representation of tickets 4110) can be measured by a value of a reward function. The reward function may be a multi-factorial function, which factors may include one or more from among: number of resolved tickets (i.e. number of tasks that will be completed by the assignment), Nᵢ, cumulative time taken to resolve them (i.e. aggregate time to completion from time at end of episode i for completed tasks), T_{N}_{ᵢ}, net consumed assets, Cᵢ, and assets utilization rate Kᵢ. The reward function may be defined as Rᵢ=F(Nᵢ, T_{N}_{ᵢ}, Cᵢ, Kᵢ), where the function, F, may be predefined, and/or may be defined by, or configured by, the reinforcement learning algorithm. The function F may be determined by various parameters such as ticketing system configuration, network management system, type of assets involved, etc.

Telecommunications network 4100 is exemplary of physical environments in which embodiments may be implemented. The pending tasks represented by tickets may be managed services, and may include, for example, hands-on field service operations, and remote network operations. The goal of the apparatus 4010 is to assign assets to tickets in a manner which leads to tickets being resolved, but furthermore, in a manner which is efficient in terms of time taken and asset utilisation. Whether assets resolve tickets remotely or via a field visit, there is a fixed set of assets available and using these a party responsible for resolving pending tasks in the physical environment 4100, such as a managed services team, aims to resolve the tickets whilst keeping resources (assets) as free as possible for future tickets. Simply increasing the number of assets may not be possible or feasible, so effective usage of the available assets is enabled by embodiments. Embodiments provide an efficient mechanism to assign and handle available assets, by using a reinforcement learning algorithm to formulate a mapping to resolve as many tickets as possible with minimum assets required.

A further worked example is now provided, with reference to FIG. 4. An exemplary ticket represents a pending task with information exemplary of a task characteristic. For example, the characteristic may be type or description of pending task, and may indicate a power outage requiring resolution. The reinforcement learning algorithm from monitoring previous tickets indicating the same type and the outcomes thereof, is aware that a minimum set of assets to reach a resolution is, for example, X assets. The X assets may include manpower and/or equipment, and the usage of these resources represents a cost (either financial or in terms of eg. CO2 emissions). For instance, consider a scenario in which an embodiment is not implemented (but provided for comparative purposes to aid understanding), and a field service engineer is required to go to the site and repair the fault as soon as the ticket is received, and then in the time being another ticket is received which also requires an engineer to go and do the site repair, and the new site location is quite close to where the first site is, it would be good to send the same person to the new site also rather than send a new service engineer to go there. There may be a delay in resolving the second ticket but if there are only two engineers (assets) available to oversee the network, it may be preferable to preserve the second engineer incase another site outage occurs where they are required to go to a site which is very far from these two sites. In the absence of the embodiment, in the comparative example, dealing with each ticket as soon as it arrives in a manner which considers only the needs of the most recently arrived ticket would have resulted in sending both the engineers to similar sites, which may have resolved the two tickets very fast, but a potential third ticket resolution would be severely delayed. An embodiment implemented on the same situation, by waiting for the end of an episode and then focusing not solely on the local optimal solution per ticket, but focusing on global optimal solutions for the episode, results in more efficient overall resource usage. The reinforcement learning algorithm learns how to use assets for a global optimal reward by observing patterns and over time learns best assignment patterns (i.e. mappings) for given combinations of pending tasks and given combinations of resources available to perform the tasks.

In order to explain the effect of embodiments, a comparative example will be provided in which an embodiment is not implemented.

In the comparative example in which an embodiment is not applied, consider the following tickets arrive at the given timings:

| | Time of | Time taken | | Resource |
|---|---|---|---|---|
| TaskID | arrival | (in hours) | TT Type | Assigned |
| T1 | 00:00 | 2 | Password reset | A1 |
| | | | required | |
| T2 | 00:10 | 4 | Hardware | Queued |
| | | | replacement | |
| T3 | 00:45 | 1 | Power outage | Queued |

The assets are assigned to the pending tasks as the respective tickets (representing tasks) arrive in the system, on a first-come-first-served basis. If an asset that is required for completing a newly pending task is locked by a previous task, the ticket for the newly-pending task is simply queued and waits until the release of the required asset.

An inventory of resources which are available for assignment to pending tasks is provided below:

### Asset Repository Information

| | | Handling hardware |
|---|---|---|
| Asset | | replacements |
| (resource | Skillset | (resource |
| ID) | (resource characteristic) | characteristic) |
| A1 | Power outages | Yes |
| | Reconfiguration/data fix | |
| | Password Reset | |
| | Documentation update | |
| A2 | Password Reset | No |
| | Documentation update | |
| A3 | 3PP Issue | No |

According to a first-come first-served asset mapping system in the comparative example, the overall turnover of ticket resolutions after 6 hours would be just 1. As the ticket is created, the resource A1 is assigned to the task as the resource A1 has the required skillset. However, this has the consequence that A1 is locked on the task for the next 2 hours and hence when the next set ticket is created, A1 is unavailable. Likewise, A1 is immediately assigned to the task represented by T2 after completion of T1, and hence when T3 arrives A1 is unavailable. T1 is completed at 02:00 (T_{N1}=2:00); T2 is completed at 06:00 (T_{N2}=5:50); and T3 is completed at 07:00 (T_{N3}=6:15), so T_{N}=02:00+05:50+06:15=14:05.

Now an implementation of an embodiment to the same set of tasks/tickets will be presented. Consider hourly episodes, starting on the hour (so that T1 arrives in the episode 00:00 to 01:00). In general, at the end of episode i, the physical environment is represented by a set of pending tasks Sᵢ∈{T₁, T₂, T₃}, and based on the representation of the pending tasks, a representation of the resources (i.e. the inventory), and the reward function, the reinforcement learning algorithm will formulate an assignment, Aᵢ, ∈{A₁, A₂, A₃}.

The reward function here is Rᵢ=F(Nᵢ, T_{N}_{ᵢ}, Cᵢ), where Nᵢ=3. Since Nᵢ is a constant, the reward function is maximized by min(T_{N}_{ᵢ}) and optimizing usage rate Cᵢ.

The apparatus 4010 waits until the end of the episode, at 0100, to execute the assignment. At 01:00, the task assignment is as follows:

| | Time of | Time taken | | Resource |
|---|---|---|---|---|
| TaskID | arrival | (in hours) | TT Type | Assigned |
| T1 | 00:00 | 2 | Password reset | A2 |
| | | | required | |
| T2 | 00:10 | 4 | Hardware | A1 |
| | | | replacement | |
| T3 | 00:45 | 1 | Power outage | Queued (A1) |

At 05:10, the status is:

| | Time of | Time taken | | |
|---|---|---|---|---|
| TaskID | arrival | (in hours) | TT Type | Status |
| T1 | 00:00 | 2 | Password reset | Completed (A2) |
| | | | required | at 01:00 + |
| | | | | 2:00 = 03:00 |
| T2 | 00:10 | 4 | Hardware | Completed (A1) |
| | | | replacement | at 01:00 + |
| | | | | 4:00 = 05:00 |
| T3 | 00:45 | 1 | Power outage | Completed (A1) |
| | | | | at 01:00 + |
| | | | | 1:00 = 02:00 |

After 6 hours, the turn around of number of tickets resolved would be 3. This way the system learns to allocate a particular resource to a task to achieve best possible results of highest ticket resolution. T1 is completed at 03:00 (T_{N}, =3:00); T2 is completed at 05:00 (T_{N2}=4:50); and T3 is completed at 02:00 (T_{N3}=1:15), so T_{N}=03:00+04:50+01:15=8:05.

The reinforcement learning algorithm formulates assignments and monitors outcomes via information fed back from the resources in the physical environment to the apparatus. Over the time, the reinforcement learning algorithm learns the set or kind of assets needed for different type of pending tasks in the physical environment. This learning comes from the representation of the tasks in the ticket description in some form, and the asset(s) required and time taken to resolve tasks. The reinforcement learning algorithm stores associations between task characteristics and resource characteristics, and adapts the associations based on outcomes of historical assignments, to utilize the associations for assigning assets to new tickets. So, when tickets are included in a representation of pending tasks at the end of an episode, and the reinforcement learning algorithm recognizes a task characteristic that has been present before in a historical ticket to which asset(s) were assigned and an outcome reported (and used to record or modify an association between the asset and the task, or characteristics thereof), the reinforcement learning algorithm utilizes the stored association in formulating a mapping. The reinforcement learning algorithm may use the associations so that resources allocated for the particular ticket will not be surplus and can be used for the resolution of future incoming tickets (i.e. by favouring assets suitable for a task and which have fewer associations to other task characteristics). In other words, the reinforcement learning algorithm may be configured to favour mappings of resources to tasks in which the resource has a stored association with the pending task (or a characteristic thereof), and which is associated with fewer task characteristics, than a resource with the pending task (or a characteristic thereof), and which is associated with a greater number of task characteristics.

So, the reinforcement learning algorithm based helps in efficient allocation of assets to the tickets raised and becomes effective in selecting assignments which preserve assets for future tickets.

One of the major tasks in a managed services setting is inventory management. A particular challenge is demand forecasting. At any time, it is beneficial to have resources in the inventory that are available for future pending tasks, rather than all resources being utilized at any one time. If any resources are required in the inventory, the vendor must be informed well in advance to supply the said resources. The reinforcement learning algorithm may use historical patterns of pending task arrival types and times to predict when pending tasks of particular types will arrive, and thus may take these predictions into account in the mapping.

1-27. (canceled)

28. An apparatus comprising processor circuitry and memory circuitry, the memory circuitry storing processing instructions which, when executed by the processor circuitry, cause the processor circuitry to:
at the end of a finite time period, perform an assignment of resources, from a finite set of resources for performing tasks in a physical environment, to pending tasks, the performing including formulating the assignment, wherein formulating the assignment comprises:
using a reinforcement learning algorithm to formulate a mapping that optimizes a reward function value, the reward function value being a value generated by a predetermined reward function based on an inventory representing the resources, a representation of the pending tasks, and the mapping, the mapping being a mapping of individual resources from the inventory to individual pending tasks in the representation of the pending tasks, the formulated assignment being in accordance with the formulated mapping.

29. The apparatus of claim 28, wherein:
the representation of the pending tasks comprises, for each pending task, one or more task characteristics;
the inventory comprises, for each resource represented in the inventory, one or more resource characteristics;
the reinforcement learning algorithm is configured to learn and store associations between task characteristics and resource characteristics; and
formulating the mapping includes constraining the mapping of individual resources from the inventory to resources having a resource characteristic associated with a task characteristic of the respective individual pending task in the stored associations.

30. The apparatus of claim 29, wherein:
the reinforcement learning algorithm is configured to learn and store an association between a task characteristic and a resource characteristic, in response to a notification that a resource having the resource characteristic and having been assigned to a task having the task characteristic, has successfully performed the task.

31. The apparatus of claim 30, wherein
the reinforcement learning algorithm is configured to learn and store associations between task characteristics and resource characteristics in response to receiving information representing outcomes of historical assignments of resources to tasks, and the respective resource characteristics and task characteristics, wherein the stored associations include a quantitative assessment of a strength of association between a particular resource characteristic and a particular task characteristic, the quantitative assessment between the particular resource characteristic and the particular task characteristic being increased in response to an indication of a positive outcome of an assignment of a resource having the particular resource characteristic to a task having the particular task characteristic.

32. The apparatus of claim 31, wherein:
the quantitative assessment between the particular resource characteristic and the particular task characteristic is decreased in response to an indication of a negative outcome of an assignment of a resource having the particular resource characteristic to a task having the particular task characteristic.

33. The apparatus of claim 28, wherein the assigning of resources for performing tasks to pending tasks is repeated at the end of each of a series of finite time periods following the finite time period.

34. The apparatus of claim 28, wherein the predetermined reward function is a function of factors resulting from the formulated mapping, the factors including a number of tasks predicted for completion and a cumulative time to completion of the number of tasks.

35. The apparatus of claim 34, wherein:
the resources include one or more resources consumed by performing the tasks;
the inventory comprises an indication of a consumption overhead of the resources; and
the factors further include a predicted cumulative consumption overhead of the mapped resources.

36. The apparatus of claim 28, wherein the predetermined reward function is based on factors including a usage rate of the finite set of resources, there being a negative relation between reward function value optimization and the usage rate.

37. The apparatus of claim 28, wherein:
the physical environment is a physical apparatus, each pending task is a technical fault in the physical apparatus, and the representation of the pending tasks is a respective fault report of each technical fault; and
the resources for performing tasks are fault resolution resources for resolving technical faults.

38. The apparatus of claim 37, wherein the physical apparatus is a telecommunications network.

39. The apparatus of claim 28, further comprising:
interface circuitry, the interface circuitry configured to assign the resources in accordance with the formulated mapping by communicating the formulated mapping to the set of resources.

40. A method, comprising:
at the end of a finite time period, performing an assignment of resources from a finite set of resources for performing tasks in a physical environment to pending tasks, the performing including formulating the assignment, wherein formulating the assignment comprises:
using a reinforcement learning algorithm to formulate a mapping that optimizes a reward function value, the reward function value being a value generated by a predetermined reward function based on an inventory representing the resources, a representation of the pending tasks, and the mapping, the mapping being a mapping of individual resources from the inventory to individual pending tasks in the representation of the pending tasks, the formulated assignment being in accordance with the formulated mapping.

41. The method of claim 40, wherein:
the representation of the pending tasks comprises, for each pending task, one or more task characteristics;
the inventory comprises, for each resource represented in the inventory, one or more resource characteristics;
the reinforcement learning algorithm is configured to learn and store associations between task characteristics and resource characteristics; and
formulating the mapping includes constraining the mapping of individual resources from the inventory to resources having a resource characteristic associated with a task characteristic of the respective individual pending task in the stored associations.

42. The method of claim 41, wherein:
the reinforcement learning algorithm is configured to learn and store an association between a task characteristic and a resource characteristic in response to a notification that a resource having the resource characteristic and having been assigned to a task having the task characteristic, has successfully performed the task.

43. The method of claim 42, wherein:
the reinforcement learning algorithm is configured to learn and store associations between task characteristics and resource characteristics in response to receiving information representing outcomes of historical assignments of resources to tasks, and the respective resource characteristics and task characteristics, wherein the stored associations include a quantitative assessment of a strength of association between a particular resource characteristic and a particular task characteristic, the quantitative assessment between the particular resource characteristic and the particular task characteristic being increased in response to an indication of a positive outcome of an assignment of a resource having the particular resource characteristic to a task having the particular task characteristic.

44. The method of claim 43, wherein:
the quantitative assessment between the particular resource characteristic and the particular task characteristic is decreased in response to an indication of a negative outcome of an assignment of a resource having the particular resource characteristic to a task having the particular task characteristic.

45. The method of claim 40, wherein the assigning of resources for performing tasks to pending tasks is repeated at the end of each of a series of finite time periods following the finite time period.

46. The method of claim 40, wherein the predetermined reward function is a function of factors resulting from the formulated mapping, the factors including a number of tasks predicted for completion and a cumulative time to completion of the number of tasks.

47. The method of claim 46, wherein:
the resources include one or more resources consumed by performing the tasks;
the inventory comprises an indication of a consumption overhead of the resources; and
the factors further include a predicted cumulative consumption overhead of the mapped resources.
